(19) United States
(12) Patent Application Publication
(10) Pub. No.: US 2026/0138290 A1
(43) Pub. Date: May 21, 2026

(54) ROBOTIC PICKING STATION

(71) Applicant: Ocado Innovation Limited, Hatfield (GB)

(72) Inventors: Anthony MARINO, Toronto (CA); Pranit TRIVEDI, Toronto (CA); Sagar SAXENA, Toronto (CA)

(21) Appl. No.: 19/118,310

(22) PCT Filed: Oct. 19, 2023
(86) PCT No.: PCT/EP2023/079202

§ 371 Date: Apr. 3, 2025

Related U.S. Application Data
(60) Provisional application No. 63/418,310, filed on Oct. 21, 2022.

(51) Int. Cl. B25J 15/06; B25J 5/02; B25J 19/00; B65G 1/04

(52) U.S. Cl. CPC B25J 15/0616; B25J 5/02; B25J 19/002; B65G 1/0464

(57) ABSTRACT

A robotic picking station for use in a grid-based storage system comprising a robotic manipulator comprising a suction device configured to releasably engage an item and a low pressure circuit comprising a vacuum source, mounted on the robotic manipulator, for providing a vacuum pressure at the suction device.

### TECHNICAL FIELD

The present invention relates generally to the field of picking stations for use in warehouses and/or fulfilment centres.

### BACKGROUND

Online retail businesses selling multiple product lines, such as online grocers and supermarkets, require systems that are able to store tens or even hundreds of thousands of different product lines. The use of single-product stacks in such cases can be impractical, since a very large floor area would be required to accommodate all of the stacks required. Furthermore, it can be desirable only to store small quantities of some items, such as perishables or infrequently-ordered goods, making single-product stacks an inefficient solution.

PCT Publication No. WO2015/185628A (Ocado) describes a known storage and fulfilment system in which stacks of bins or containers are arranged within a framework structure. The bins or containers are accessed by load-handling devices operating on tracks located on the top of the frame structure. The load-handling devices are configured to lift bins or containers out from the stacks, and multiple load-handling devices can co-operating to access bins or containers located in the lowest positions of the stack. A system of this type is illustrated schematically in FIGS. 1 to 5 of the accompanying drawings.

FIG. 1 illustrates an automated storage and retrieval structure 1 comprising upright members 3 and horizontal members 5, 7 supported by the upright members 3. The horizontal members 7 extend parallel to one another and the illustrated x-axis. The horizontal members 5 extend parallel to one another and the illustrated y-axis, and transversely to the horizontal members 7. The upright members 3 extend parallel to one another and the illustrated z-axis, and transversely to the horizontal members 5, 7. The horizontal members 5, 7 form a grid pattern defining a plurality of grid cells. In the illustrated example, storage containers 9 are arranged in stacks 11, with each stack 11 being located beneath a respective grid cell.

FIG. 2 shows a large-scale plan view of a section of track structure 13 forming part of the storage structure 1 illustrated in FIG. 1. The track structure 13 is located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow storage containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure are also envisaged. FIG. 3 shows a plurality of load-handling devices 31 moving on top of the storage structure 1 illustrated in FIG. 1. The load-handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19, separated by channels 21, 23, allow bots 31 to occupy (or pass one another on) neighbouring grid cells without colliding with one another.

As illustrated in detail in FIG. 4, a bot 31 comprises a body 33 on which are mounted one or more components which enable the bot 31 to perform its intended functions. These functions may include moving across the storage structure 1 on the track structure 13 and raising or lowering storage containers 9 (e.g. from or to stacks 11) so that the bot 31 can retrieve or deposit storage containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (side and further two wheels 35 not visible in FIG. 4).

The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19.

The bot 31 also comprises container-lifting means 39 configured to raise and lower containers 9. The illustrated container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with features of the containers 9. For instance, the containers 9 may be provided with one or more apertures in their upper sides with which the engaging means can engage. Alternatively or additionally, the engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

As can be seen in FIG. 5, the body 33 of the illustrated bot 31 has an upper portion 45 and a lower portion 47. The upper portion 45 is configured to house one or more operation components (not shown), and the lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space of the bot 31 may not be within the body 33 of the bot 31. For example, in some embodiments, the container-receiving space may be adjacent to the body 33 of the bot 31, e.g. in a cantilever arrangement with the weight of the body 33 of the bot 31 counterbalancing the weight of the container to be lifted. In such embodiments, a frame or arms of the container-lifting means 39 may protrude horizontally from the body 33 of the bot 31, and the tapes/reels 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

As shown in FIG. 3, a plurality of identical load-handling devices 31 are provided, so that each load-handling device 31 can operate simultaneously to increase the throughput of the system. The system illustrated in FIG. 3 may include specific locations, known as ports, at which containers can be transferred into or out of the system. An additional conveyor system (not shown) is associated with each port, so that containers 9 transported to a port by a load-handling device 31 can be transferred to another location by the conveyor system, for example to a picking station (not shown). Similarly, containers 9 can be moved by the conveyor system to a port from an external location, for example to a container-filling station (not shown), and transported to a stack 12 by the load-handling devices 30 to replenish the stock in the system.

Each load-handling device 31 can lift and move one container 9 at a time. If it is necessary to retrieve a container 9 (“target container 9”) that is not located on the top of a stack, then the overlying containers 9 (“non-target containers 9”) must first be moved to allow access to the target container. This is achieved in an operation referred to hereafter as “digging”. During a digging operation, one of the load-handling devices 31 sequentially lifts each non-target container from the stack 11 containing the target container and places it in a vacant position within another stack 11. The target container can then be accessed by the load-handling device 31 and moved to a port for further transportation.

Each of the load-handling devices 31 is under the control of a central computer. Each individual container 9 in the system is tracked so that it can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a huge range of different items in the containers, while allowing reasonably economical access to all of the containers when required for picking.

With reference to FIG. 6, the system may further comprise a robotic picking station, generally designated by 50, mounted on top of the storage and retrieval structure 1, alongside the load-handling devices 31 (not shown). The robotic picking station 50 comprises a robotic manipulator 52 comprising a robotic arm 54 and an end effector 56 for releasably engaging a product to be manipulated, together with several designated grid cells 60, 62. The robotic manipulator 52 is mounted on a plinth 58 above a single grid cell 60 and, depending on its location on the structure 1, can be surrounded by up to eight other grid cells 62 as shown in FIG. 6. In general, the robotic manipulator 52 is configured to pick an item or product from any one of the containers 9 located in one of the designated grid cells 62 and place it in a container 9 located in another of the designated grid cells 62, and the load-handling devices 31 collect containers 9 from and deliver them to the designated grid cells 62 as necessary. In this way, the robotic picking station 50 and the load-handling devices 31 work in conjunction to fulfil a customer order or redistribute products throughout the storage and retrieval structure 1. The end effector 56 comprises a suction device 64 connected to a vacuum source in the form of a rotary vane pump (not shown). The vane pump forms part of a low pressure circuit configured to provide a vacuum pressure at the suction device 64, enabling it to attach to a product to be manipulated. The vane pump is positioned away from the top of the storage and retrieval structure 1 due to its size and weight, and so as not to occupy any grid cells. Instead, it is typically positioned at ground level, where it can be easily accessed, making installation and maintenance more straightforward. However, this arrangement poses a number of problems. First, positioning the vane pump at ground level can present a burn hazard because of the heat it generates during use. Second, because of the distance between the vane pump and suction device 64, which can be in the order of several metres, a large diameter vacuum line 66 must be used in order to minimise the pressure drop between the vane pump and suction device 64. However, in order to prevent its collapse due to the vacuum pressure, the vacuum line 66 must be reinforced, making it reasonably stiff. This can reduce the dexterity of the robotic manipulator 52 since it is necessary to mount the vacuum line 66 on the robotic arm 54 in order to route it to the suction device 64. Lastly, the use of vane pumps is not appropriate for some environments (e.g. chilled areas) since they are typically not rated to work below 5 deg C.

It is against this background that the invention was devised.

### SUMMARY

Accordingly, there is provided, in one aspect, a robotic picking station for use in a grid-based storage system. The robotic picking station comprises a robotic manipulator comprising a suction device configured to releasably engage an item or product and a low pressure circuit comprising a vacuum source for providing a vacuum pressure at the suction device, wherein the vacuum source is mounted on the robotic manipulator. There is a generally accepted notion within the field of robotic manipulators that one should avoid mounting equipment on the robotic manipulator itself wherever possible, and above all heavy and/or bulky items, since doing so can take away from the performance and dexterity of the manipulator. This is particularly inadvisable when alternative options exist. So mounting the vacuum source on the robotic manipulator is counter-intuitive, flouting expectations and norms.

Optionally, the vacuum source is movable relative to a base of the robotic manipulator.

Optionally, the vacuum source is movable about a substantially vertical axis of the robotic manipulator.

Optionally, the substantially vertical axis defines a rotational axis of a movable joint of the robotic manipulator and wherein the vacuum source is mounted on the robotic manipulator above the movable joint.

Optionally, the vacuum source is mounted on the base of the robotic manipulator.

Optionally, the robotic picking station further comprises a support mounted to the base, the support being configured to carry the vacuum source.

Optionally, the vacuum source is movable about a substantially horizontal axis of the robotic manipulator.

Optionally, the vacuum source is positioned on the robotic manipulator such that, in use, it counterbalances a load carried by the suction device.

Optionally, the robotic manipulator further comprises a means for adjusting the distance between the vacuum source and the substantially horizontal axis.

Optionally, the low pressure circuit further comprises a vacuum filter positioned between the suction device and the vacuum source.

Optionally, the vacuum filter is mounted on the robotic manipulator.

Optionally, the vacuum filter is mounted on a link of the robotic manipulator.

Optionally, the vacuum source comprises a venturi vacuum generator connectable to a pressure source for providing a pressurised air supply thereto.

Optionally, the vacuum source comprises a plurality of venturi vacuum generators, an air supply manifold connectable to the pressure source, and a vacuum manifold fluidically connecting the plurality of venturi vacuum generators to the suction device.

Optionally, the low pressure circuit further comprises a plurality of push-to-connect fittings.

Optionally, the low pressure circuit further comprises food grade tubing.

Optionally, the robotic picking station further comprises a plinth for mounting the robotic manipulator to one or more framework members of the grid-based storage system, such that the robotic manipulator is received within a single grid cell of the storage system.

Optionally, the pressure source is connectable to the venturi vacuum generator by a tube and wherein the plinth comprises a movable bracket defining a conduit through which the tube is fed.

According to a second aspect, there is provided a grid-based storage and retrieval system comprising a first set of tracks extending in a first direction and a second set of tracks extending in a second direction transverse to the first direction, to form a grid comprising a plurality of grid cells. The grid-based storage system further comprises a framework structure on which the first and second set of tracks are received such that a stack of containers may be stored below each of the plurality of grid cells, and a robotic picking station according to the first aspect.

### BRIEF DESCRIPTION OF THE DRAWINGS

These and other aspects of the invention will now be described, by way of example only, with reference to the accompanying drawing, in which:

FIG. 1 shows a schematic depiction of an automated storage and retrieval structure;

FIG. 2 shows a schematic depiction of a plan view of a section of track structure forming part of the storage structure of FIG. 1;

FIG. 3 shows a schematic depiction of a plurality of load-handling devices moving on top of the storage structure of FIG. 1;

FIGS. 4 and 5 show a schematic depiction of a load-handling device interacting with a container;

FIG. 6 shows a schematic depiction of a known robotic picking station;

FIGS. 7a and 7b show schematic depiction of a robotic picking station according to an embodiment of the invention and a robotic manipulator used in the picking station;

FIGS. 8a and 8b are isometric depictions of a vacuum source for use with the robotic picking station of FIG. 7; and,

FIGS. 9a and 9b shows a schematic depiction of an alternative robotic manipulator according to an embodiment of the invention for use in the robotic picking station of FIG. 7.

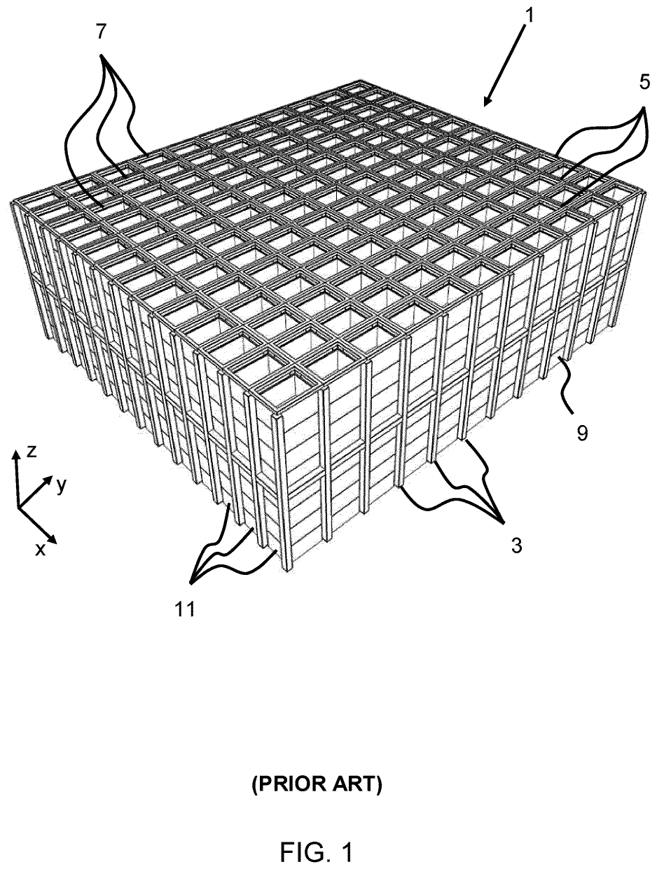

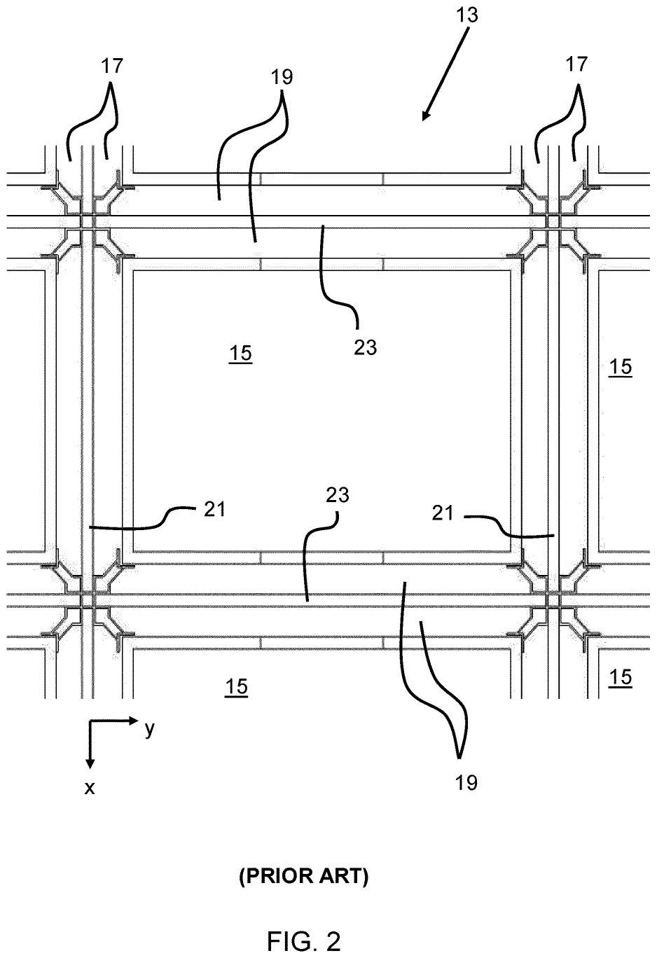

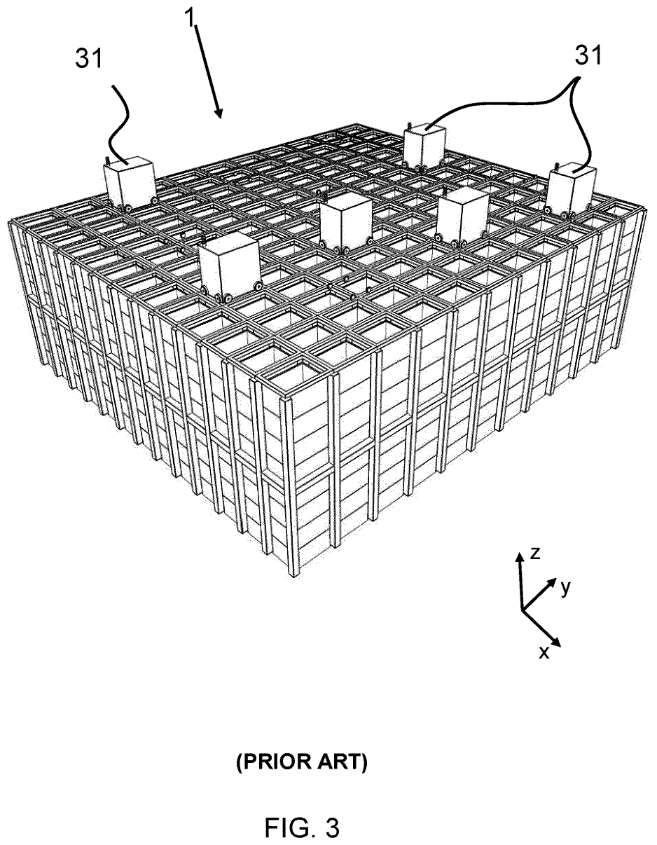

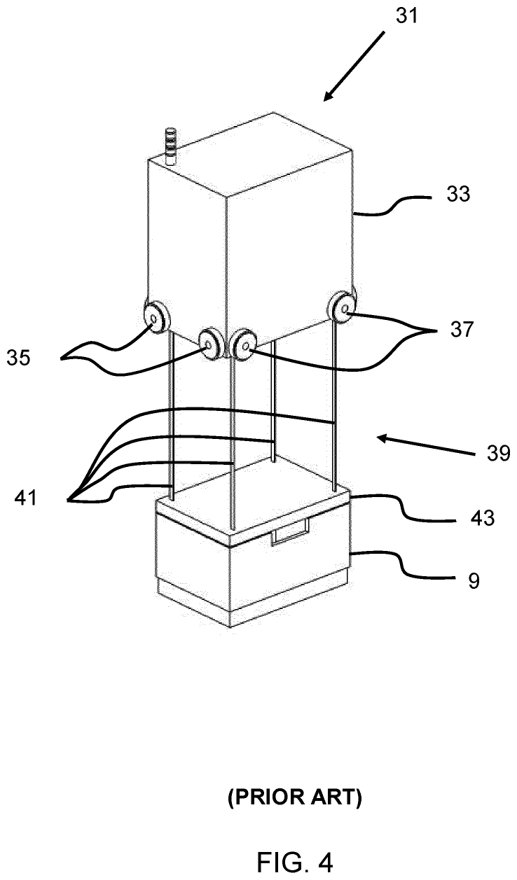

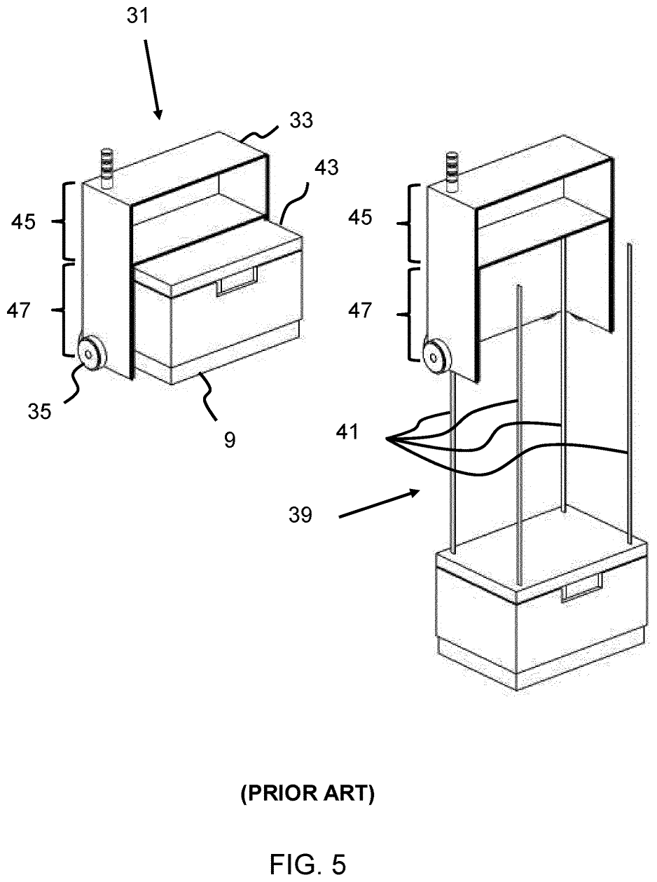

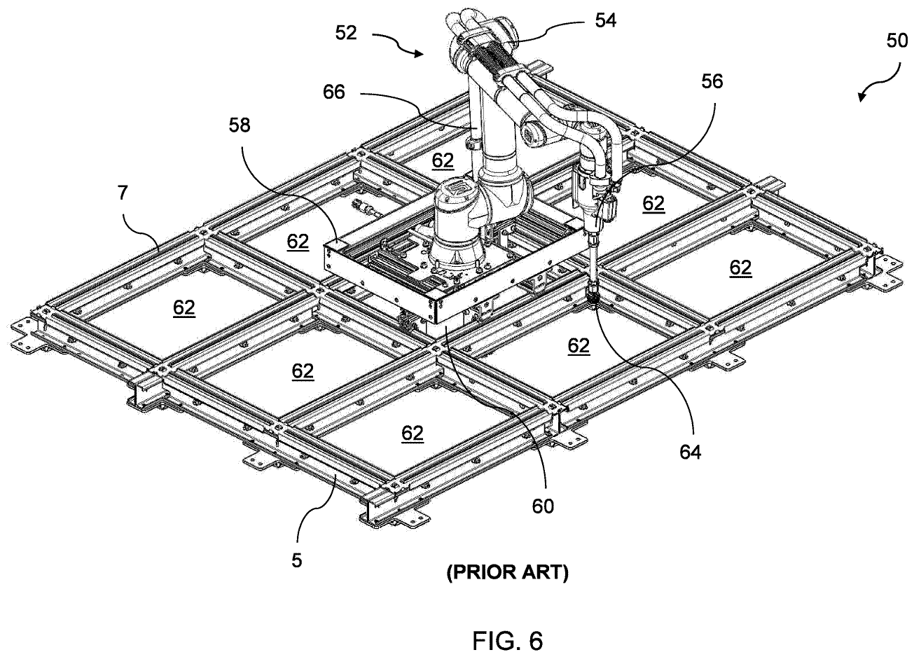

In the drawings, like features are denoted by like reference signs where appropriate.

### DETAILED DESCRIPTION

In the following description, some specific details are included to provide a thorough understanding of the disclosed examples. One skilled in the relevant art, however, will recognise that other examples may be practised without one or more of these specific details, or with other components, materials, etc., and structural changes may be made without departing from the scope of the invention as defined in the appended claims. Moreover, references in the following description to any terms having an implied orientation are not intended to be limiting and refer only to the orientation of the features as shown in the accompanying drawings. In some instances, well-known features or systems, such as processors, sensors, storage devices, network interfaces, fasteners, electrical connectors, and the like are not shown or described in detail to avoid unnecessarily obscuring descriptions of the disclosed embodiment.

Unless the context requires otherwise, throughout the specification and the appended claims, the word “comprise” and variations thereof, such as, “comprises” and “comprising” are to be construed in an open, inclusive sense that is as “including, but not limited to.”

Reference throughout this specification to “one”, “an”, or “another” applied to “embodiment”, “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

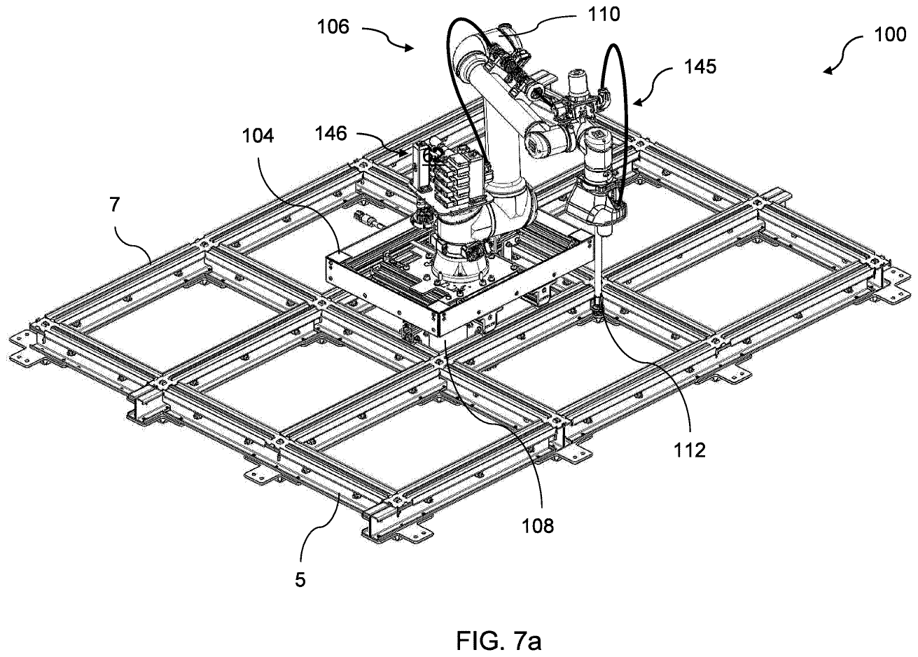

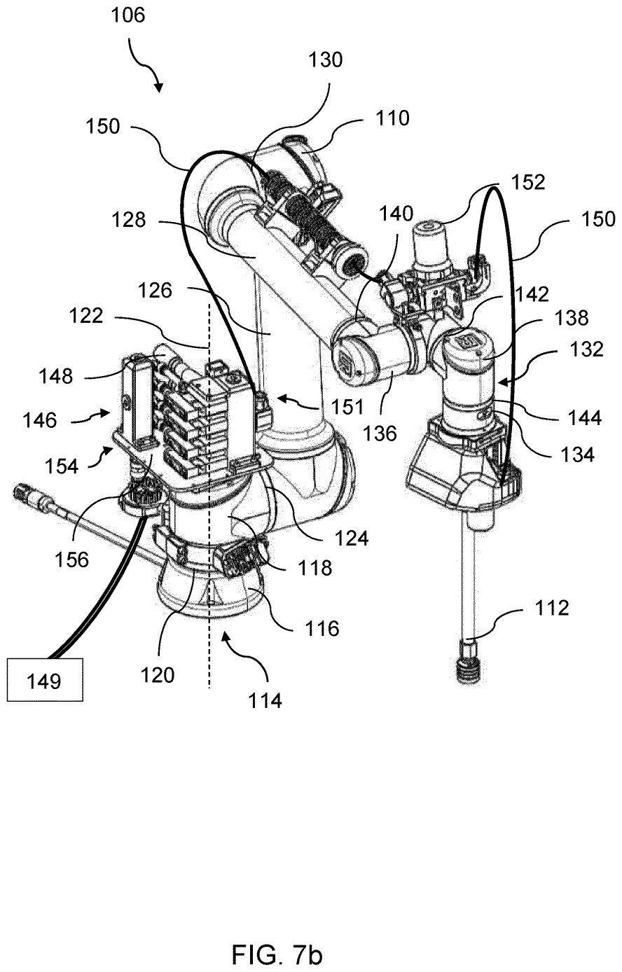

It should be noted that, as used in this specification and the appended claims, the users forms “a”, “an”, and “the” include plural referents unless the content clearly dictates otherwise. It should also be noted that the term “or” is generally employed in its sense including “and/or” unless the content clearly dictates otherwise. FIG. 7a shows a schematic depiction of a robotic picking station 100 according to an embodiment of the invention. The robotic picking station 100 is mounted on top of a grid-based storage and retrieval system 102 similar to the known system previously described. The robotic picking station 100 comprises a plinth 104 upon which a robotic manipulator 106 is mounted. The plinth 104 is of a size and shape such that it may be received within an aperture 108 of a grid cell formed by intersecting horizontal members 5, 7. The plinth 104 is connected to the framework of the system 102 such that the robotic manipulator 106 arm is mounted thereon. For example, the plinth 104 may be connected to one or more of the upright members 3 of the system 102. Alternatively or additionally, the plinth 104 may be connected to one or more of the horizontal members 5, 7 of the system 102. The surface of the plinth 104 may extend across substantially the entirety of the aperture 108 of the grid cell in which it is received. This will reduce the risk that a dropped product may fall into the system 102, potentially interfering with its operation. Alternatively, the surface of the plinth 104 may only partially extend across the area of the grid cell in which it is received.

The robotic manipulator 106 comprises a robotic arm 110 and an end effector in the form of a suction device 112 configured to releasably engage an item. The precise configuration of the robotic arm 110 is not central to the invention, and so will not be described in great detail. With reference to FIG. 7b, in this example of the robotic manipulator 106, the robotic arm 110 comprises a base 114 and seven links, all connected by six joints. The base 114 extends substantially vertically from the plinth 104 and comprises a lower base link 116 and an upper base link 118 connected by base joint 120. The base joint 120 is configured to enable the upper base link 118 to rotate relative to the lower base link 116 about a substantially vertical axis 122. The upper base link 118 is rotatably connected, by a shoulder joint 124, to an upper arm link 126, which is also rotatably connected to a lower arm link 128 by an elbow joint 130. The robotic arm 110 further comprises a wrist 132 and a tool flange 134 configured to hold the suction device 112. The wrist 132 comprises two wrist links 136, 138 and three wrist joints 140, 142, 144 connecting the lower arm 128 and tool flange 134. Each joint 120, 124, 130, 140, 142, 144 may be selectively actuated such that the suction device 112 may be moved within six degrees of freedom, enabling the robotic arm 110 to engage a product stored within one container and move it to another container. Other robotic arms, comprising a greater or fewer number of links and joints, will be known to the skilled person.

The robotic picking station 100 further comprises a low pressure circuit 145 comprising a vacuum source 146 configured to provide a vacuum pressure at the suction device 112. In this example, the vacuum source 146 comprises an array of venturi vacuum generators 148 (hereinafter “the array 148”) connectable to a pressure source 149 for providing a pressurised air supply thereto. In this embodiment, the array 148 comprises four venture vacuum generators 148. The pressure source may be a standalone pump or a reservoir of pressurised air configured to supply the facility within which the robotic picking station 100 is installed. The low pressure circuit 145 further comprises a flexible hose 150 extending between a vacuum side 151 of the array 148 and the suction device 112 for supplying a vacuum pressure at the suction device 112, together with a vacuum filter 152 connected to the hose 150 between the array 148 and suction device 112. The vacuum filter 152 functions to isolate the array 148 from debris picked up from the suction device 112. In this example, the vacuum filter 152 is mounted on one of the wrist links 136 of the robotic arm 110, feasibly as near to the suction device 112 as this configuration of the robotic arm 110 allows.

The array 148 is mounted on the robotic manipulator 106 and is movable relative to the lower base link 116, which is fixedly secured to the plinth 104. In this example, the array 148 is mounted on the upper base link 118, directly above the base joint 120 as close to the vertical axis 122 as is reasonably practicable, so as to rotate with the upper base link 118 about the substantially vertical axis 122. Mounting the array 148 radially close to the vertical axis 122 minimises its moment of inertia as it moves about the axis 122. The array 148 is secured to a support 154 in the form of, in this example, a platform 156 that is mounted to the upper base link 118. The platform 156 provides additional surface area, when compared to the upper surface of the upper base link 118, upon which to carry the array 148, improving the load distribution across the base joint 120.

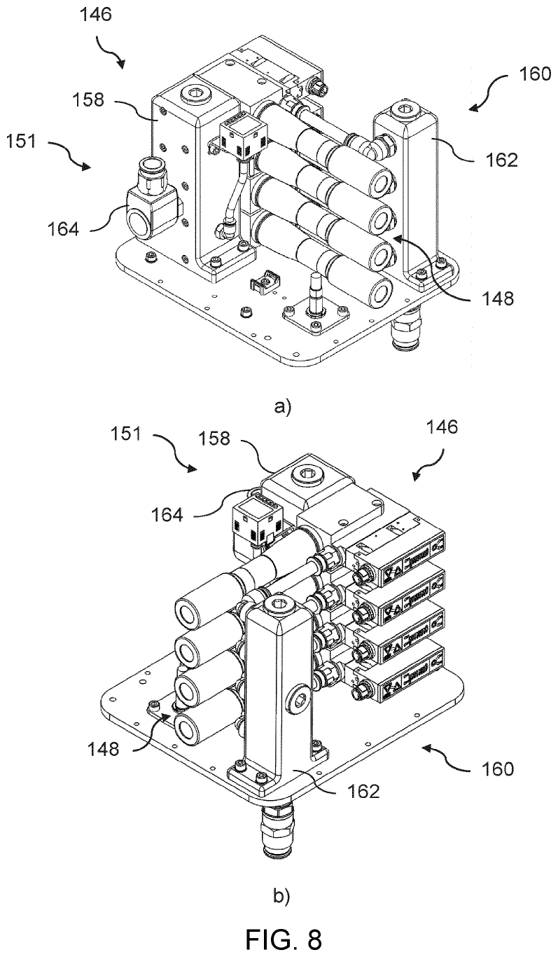

Referring to FIGS. 8a and 8b, the vacuum side 151 of the vacuum source 146 comprises a vacuum manifold 158 fluidically connecting the array 148 to the hose 150 for supplying a vacuum pressure at the suction device 112. Similarly, a pressure side 160 of the vacuum source 146 comprises an air supply manifold 162 connectable to a hose 164 for supplying a pressurised air flow from the pressure source to the array 148. The use of manifolds 158, 162 reduces the need for additional fittings or hose connecting pressure source and vacuum source 146 to the array 148, minimising pressure drop between the pressure source and the air supply manifold 162, and vacuum losses through the low pressure circuit 145. Also, both manifolds 158, 162 are configured to ensure a uniform mass flow across the array 148, further minimising pressure and vacuum losses therethrough. The vacuum source 146 further comprises a hose fitting 164 connecting the vacuum manifold 158 to the hose 150 of the low pressure circuit 145. The hose fitting 164 is rotatably mounted to the vacuum manifold 158 by a bearing block (not shown). This enables the hose fitting 164 to rotate about an axis defined by the bearing block, preventing excessive tensioning of the hose 150 as the robotic arm 110 moves relative to the vacuum source 146.

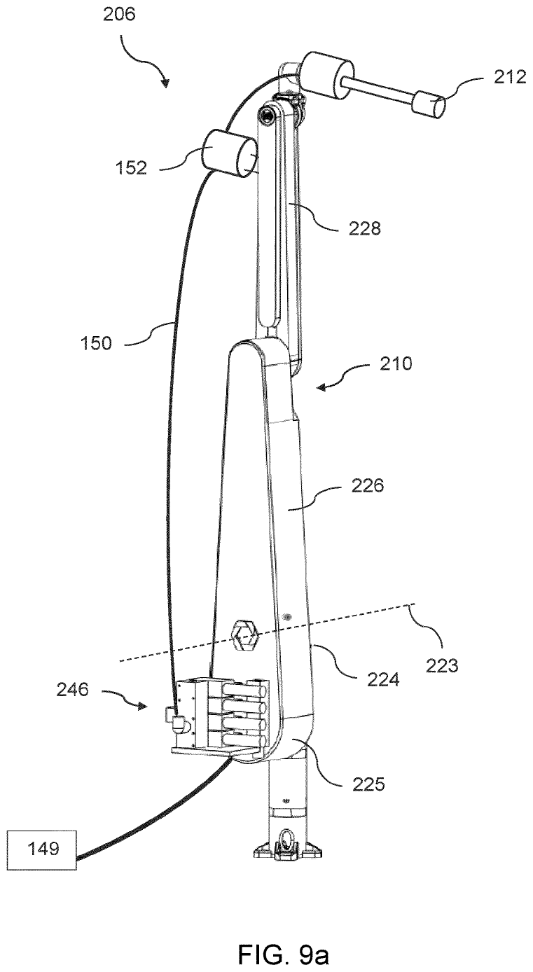

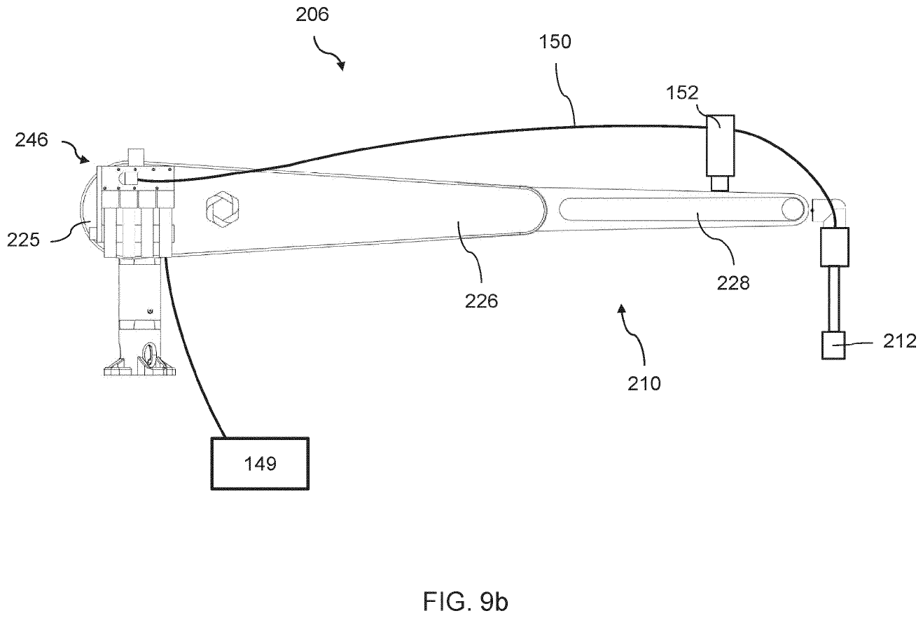

FIGS. 9a and 9b show another example of a robotic manipulator 206 for use in a robotic picking station according to the present disclosure. This example is substantially the same as the previous example except that the moderately different configuration of the robotic arm 210 enables the vacuum source 246 to be positioned on the robotic manipulator 206 such that it, in use, counterbalances a load carried by the suction device 212. Specifically, in this configuration of the robotic arm 210, the upper arm link 226 extends longitudinally either side of a substantially horizontal axis 223 defined by the shoulder joint 224, providing space at the end 225 of the upper arm link 226, distal from the lower arm link 228, for mounting the vacuum source 246. In this way, the vacuum source 246 can be used as a counterbalance, providing a leverage action to reduce the effort with which the robotic arm 210 lifts loads. In order to adjust the leverage action, making it more or less beneficial, the robotic manipulator further comprises a means for adjusting the distance between the vacuum source 246 and the horizontal axis 223. To that end, the vacuum source 246 could be mounted on a platform system configured to move towards and away from the horizontal axis 223. Alternatively, the vacuum source 246 could be mounted to a guide rail extending in the direction of the horizontal axis 223. The distance between the vacuum source 246 and the horizontal axis 223 may be varied according to the load carried by the suction device. For example, for light or no loads, the vacuum source 246 would be moved as close to the horizontal axis 223 as possible, minimising the lever action. For progressively heavier loads, the distance between the vacuum source 246 and horizontal axis 223 would be increased in order to benefit from the lever action.

1. A robotic picking station for use in a grid-based storage system, the robotic picking station comprising:
a robotic manipulator comprising a suction device configured to releasably engage an item; and,
a low pressure circuit comprising a vacuum source for providing a vacuum pressure at the suction device, wherein the vacuum source is mounted on the robotic manipulator.

2. A robotic picking station according to claim 1, wherein the vacuum source is movable relative to a base of the robotic manipulator.

3. A robotic picking station according to claim 1, wherein the vacuum source is movable about a substantially vertical axis of the robotic manipulator.

4. A robotic picking station according to claim 3, wherein the substantially vertical axis defines a rotational axis of a movable joint of the robotic manipulator and wherein the vacuum source is mounted on the robotic manipulator above the movable joint.

5. A robotic picking station according to claim 2, wherein the vacuum source is mounted on the base of the robotic manipulator.

6. A robotic picking station according to claim 5, further comprising a support mounted to the base, the support being configured to carry the vacuum source.

7. A robotic picking station according to claim 1, wherein the vacuum source is movable about a substantially horizontal axis of the robotic manipulator.

8. A robotic picking station according to claim 7, wherein the vacuum source is positioned on the robotic manipulator such that it counterbalances a load carried by the suction device.

9. A robotic picking station according to claim 8, wherein the robotic manipulator further comprises a means for adjusting the distance between the vacuum source and the substantially horizontal axis.

10. A robotic picking station according to claim 1, wherein the low pressure circuit further comprises a vacuum filter positioned between the suction device and the vacuum source.

11. A robotic picking station according to claim 10, wherein the vacuum filter is mounted on the robotic manipulator.

12. A robotic picking station according to claim 11, wherein the vacuum filter is mounted on a link of the robotic manipulator.

13. A robotic picking station according to claim 1, wherein the vacuum source comprises a venturi vacuum generator connectable to a pressure source for providing a pressurized air supply thereto.

14. A robotic picking station according to claim 13, wherein the vacuum source comprises a plurality of venturi vacuum generators, an air supply manifold connectable to the pressure source, and a vacuum manifold fluidically connecting the plurality of venturi vacuum generators to the suction device.

15. A robotic picking station according to claim 14, wherein the low pressure circuit further comprises a plurality of push-to-connect fittings.

16. A robotic picking station according to claim 1, wherein the low pressure circuit further comprises food grade tubing.

17. A robotic picking station according to claim 1, further comprising a plinth for mounting the robotic manipulator to one or more framework members of the grid-based storage system, such that the robotic manipulator is received within a single grid cell of the storage system.

18. A robotic picking station according to claim 17, wherein the pressure source is connectable to the venturi vacuum generator by a tube and wherein the plinth comprises a movable bracket defining a conduit through which the tube is fed.

19. A grid-based storage and retrieval system comprising:
a first set of tracks extending in a first direction;
a second set of tracks extending in a second direction transverse to the first direction, to form a grid comprising a plurality of grid cells;
a framework structure on which the first and second set of tracks are received such that a stack of containers may be stored below each of the plurality of grid cells; and,
a robotic picking station according to claim 1.
